(19) United States
(12) Patent Application Publication
(10) Pub. No.: US 2024/0199379 A1
(43) Pub. Date: Jun. 20, 2024

(54) SYSTEM AND METHOD FOR INCREASING FRESH AIR FLOW INSIDE AN ELEVATOR CAB

(71) Applicant: Clearway Air Solution, Inc., Studio City, CA (US)

(72) Inventors: Aaron Lazar, Studio City, CA (US); Paul Lazar, Medford, NJ (US); Margaret Tobin, New York, NY (US)

(21) Appl. No.: 18/066,229

(22) Filed: Dec. 14, 2022

(51) Int. Cl. B66B 11/02; B66B 3/00; B66B 5/00; F24F 11/52

(52) U.S. Cl. CPC B66B 11/024; B66B 3/002; B66B 5/0018; F24F 11/52; F24F 2110/50

(57) ABSTRACT

A ventilation system for an elevator cab including one or more reversible supply and exhaust fans wherein at least one of the exhaust fans is mounted on the top of the elevator cab, an air-quality monitor affixed to a side wall inside of the elevator cab wherein the air-quality monitor has a user interface for displaying air-quality information to a passenger, and an HVAC system having one or more ducts for delivering at east 150 CFM of ventilation air through the elevator's hoistway, to the elevator cab.

### BACKGROUND

### Field of Invention

The present invention relates generally to ventilation systems, and more specifically to a system and method for increasing fresh air flow inside an elevator cab.

### Related Art

Respiratory viruses are predominantly spread via aerosols which are tiny exhaled droplets small enough to linger in air and to accumulate in poorly ventilated spaces. While transmission may occur both indoors and outdoors, the risk of transmission is much higher in indoor spaces with inadequate ventilation. Outdoor transmission of viruses via aerosols has been shown to be very low.

Small, enclosed spaces such as elevators carry a high risk of transmission. Currently, buildings focus primarily on surface cleaning while science shows that aerosol transmission is a much bigger risk. Infrared light has been used in an attempt to kill airborne viruses, but this method is dangerous to use while passengers are inside of the elevator cab and it requires too much down time for the elevator cab in between use. The present invention discloses a system and method of increasing ventilation inside elevator cabs producing an indoor environment that is very similar to an outdoor environment in terms of air flow.

### SUMMARY OF INVENTION

It is to be understood that the phraseology and terminology employed herein are for the purpose of the description and should not be regarded as limiting.

The present invention is directed to a ventilation system for an elevator cab, the ventilation system including a reversible supply and exhaust fan mounted on the top of the elevator cab, an air-quality monitor affixed to a side wall inside of the elevator cab wherein the air-quality monitor has a user interface for displaying air-quality information to a passenger, and an HVAC system having one or more ducts for delivering outside air to the elevator's hoistway. The present invention may be implemented with more than one exhaust fans.

The system may include an application and/or website accessible on one or more computing devices, the application and/or website allowing a user to access air-quality information from the air-quality monitor.

These and other features of the present invention will become readily apparent upon further review of the specification and drawings.

### BRIEF DESCRIPTION OF THE DRAWINGS

Embodiments of the present invention will be described by way of example only, and not limitation, with reference to the accompanying drawings. The drawings are not necessarily drawn to scale and wherever possible, the same or like reference numbers are used throughout the drawings to refer to the same or like parts.

FIG. 1 is a side view of an embodiment of an elevator cab according to a system and method as disclosed herein; and

FIG. 2 is a block diagram showing an exemplary architecture of a system and method as disclosed herein.

### DETAILED DESCRIPTION

Humans exhale approximately 4%-6% by volume of carbon dioxide per breath. Studies continue to show that poor indoor air quality results in high levels of carbon dioxide as well as high levels of airborne illness. The ideal indoor environment is one with a lot of outside air replacing the contaminated indoor air. The present invention relates to a system and method for improving the ventilation inside of an elevator cab by, among other things, increasing the amount of fresh airflow into the cab and continuously monitoring the carbon dioxide levels inside of the cab.

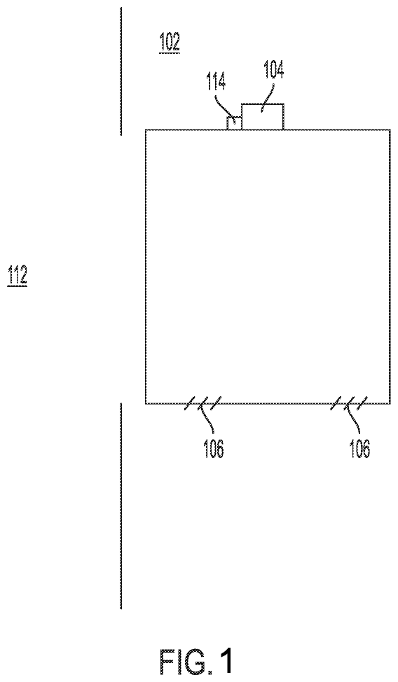

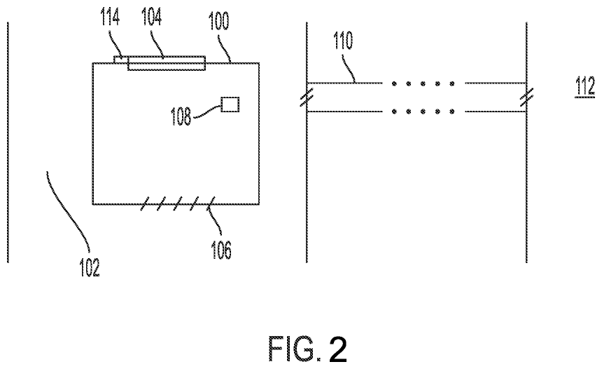

Referring now to the figures where similar reference characters denote similar elements throughout the figures, FIGS. 1 and 2 show a system and method for increasing fresh air flow inside an elevator cab 100, the system and method comprising an elevator cab 100 installed into a hoistway 102 of a building. The elevator cab having a top, a floor, and four side walls where one of the four side walls consists primarily of a door. The elevator cab having a reversible supply and exhaust fan 104 mounted at least on the top that runs continuously while the elevator is in operation. The reversible supply and exhaust fan 104 pulls fresh air from the hoistway 102 through the top of the elevator cab 100 and down through floor vents 106, or vents in other locations, in the elevator cab 100 into the hoistway 102 where it is eventually exhausted through the hoistway 102. This may either through the roof of the hoistway 102 or through other exhaust means present in the hoistway 102. Building codes generally require three to six air changes per hour. The disclosed system and method increases the air changes per hour within the elevator cab 100 to at least ten to fifteen changes per hour, up from an average of three per hour in most buildings.

Existing elevator cabs have small exhaust fans with small motors such that when a filter is added to the fan the motor burns out. In embodiments, the exhaust fan 104 size is determined based on the size of the elevator cab 100. The exhaust fan 104 must be sized appropriately to draw a minimum of 150 cubic feet per minute (CFM) of air into the elevator cab 100. The system and method may be implemented with multiple exhaust fans 104 where at least one exhaust fan 104 is mounted on the top of the elevator cab 100. The exhaust fans 104 able to draw a minimum of 150 CFM of air into the elevator cab 100 collectively. A hospital grade filter is preferably used within the one or more exhaust fans 104. The power for the reversible supply and exhaust fan 104 is preferably supplied through the elevator electrical distribution system 114 but may be supplied by other means known in the art.

An air-quality monitor 108 is affixed to a side wall inside of the elevator cab 100 in a location causing it to be easily viewable by passengers, the air-quality monitor 108 having at least one or more sensors and a user interface for displaying air-quality information to a passenger. The air quality monitor 108 is preferably wireless but may be wired. The air-quality monitor 108 is configured to test the levels of carbon dioxide in the elevator cab 100 once per minute. In embodiments, the air-quality monitor 108 may include a microcontroller or a microprocessor transmitting air-quality information to a web server.

A heating, ventilation, and air-conditioning (“HVAC”) system is installed in a building. The HVAC system having one or more pre-existing or newly installed ducts 110 for delivering outside air to the elevator's hoistway 102. Upon installation of the system and method the HVAC system undergoes air balancing/rebalancing to produce a minimum of 150 CFM of ventilation air passing through the elevator cab 100 from external sources 112 which may include passage through the building lobby, resulting in at least fifteen air changes per hour for the elevator cab 100.

The system and method may comprise a software application accessible on one or more user computing devices, the software application allowing a user to access air-quality information from the air-quality monitor 108. The software application may be a downloadable or non-downloadable application. The system and method may also include a website accessible on one or more user computing devices by way of a communications network such as the internet. The one or more user computing devices may be mobile devices, desktop devices, tablets or other computing devices known in the art for accessing software applications and websites. A user of the software application and/or website may include building ownership or staff, or a passenger or potential passenger of the elevator seeking information on the air-quality inside of the elevator cab 100.

In an embodiment, a quick response (“QR”) code is placed in the building preferably at a location nearby the elevator cab. The QR code allows a user to access the software application and/or website providing the user with additional information about the system and method and the air-quality information inside of the elevator cab as provided by the air-quality monitor 108.

This disclosure is not intended to limit the invention to the particular assembly disclosed, but, to the contrary, the intention is to cover all modifications, equivalents, and alternatives falling within the scope of the claims.

What is claimed is:

1. A ventilation system for an elevator cab comprising:
a) an elevator cab installed in a hoistway of a building, the elevator cab comprising a top, a floor, and four side walls wherein one of the four side walls comprises of a door;
b) one or more reversible supply and exhaust fans, wherein at least one of the one or more reversible supply and exhaust fans are mounted on the top of the elevator cab;
c) an air-quality monitor affixed to a side wall inside of the elevator cab, the air-quality monitor having a sensor and a user interface for displaying air-quality information to a passenger; and
d) an HVAC system having one or more ducts for delivering at least 150 CFM of ventilation air through the hoistway to the elevator cab increasing ventilation air delivery within the hoistway to achieve at least 10 to 15 air changes per hour in the elevator cab.

2. The system of claim 1, further comprising a software application accessible on one or more computing devices, the software application allowing a user to view air-quality information measured by the air-quality monitor.

3. The system of claim 1, wherein the air-quality monitor is configured to sample the air once per minute.
